(19) United States
(12) Patent Application Publication
(10) Pub. No.: US 2006/0077624 A1
(43) Pub. Date: Apr. 13, 2006

(54) Structure of a control panel of a mobile phone

(76) Inventor: Hsuan-Yu Lin, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,139

(22) Filed: Jan. 12, 2005

(30) Foreign Application Priority Data
Oct. 13, 2004 (TW) 093216234

(51) Int. Cl. G06F 1/16

(52) U.S. Cl. 361/681; 345/173

(57) ABSTRACT

A mobile phone includes a base, a screen connected to the base, and a control panel; the base has a connecting post thereon, which has an engaging protrusion; the control panel has a hole on a lower side, and it has a gap next to the hole for allowing the engaging protrusion to pass through the gap while the connecting post is being passed through the hole; the base and the control panel are joined in a separable manner with the engaging protrusion being detained in the control panel by means of the lower side of the panel; the control panel has a signal source on the lower side such that after the panel is separated from the base, it can be used to input data, which data will be transmitted to and displayed on the screen, and it can be used as a mouse to control a cursor.

### BACKGROUND OF THE INVENTION

1. Field of the invention

The present invention relates to an improvement on a control panel of a mobile phone, which control panel has a signal source on a lower side thereof such that it can be used as a mouse to control a cursor on the screen after separated from the screen, and which control panel can, after separated from the screen, be used to input data such that data are wirelessly transmitted to and displayed on the screen.

2. Brief Description of the Prior Art

Cellular phones provide people with convenience, allowing people to have phone conversation when they are driving or riding in a vehicle and from any location where signal transmission is OK between the phones and the base stations.

The various ways to control mobile phones include the use of directional (upward, downward, leftward, and rightward) buttons, and the use of touch screens, which are developed for suiting the powerful functions of modern mobile phones.

However, development of mobile phones are very fast, and modem mobile phones are made with more and more powerful functions, and the current ways to control mobile phones, e.g. the use of directional buttons and touch screens, don't seem to be convenient enough when people use the advanced functions of modern mobile phones, especially when it comes to using the Internet service on the mobile phones.

### SUMMARY OF THE INVENTION

It is a main object of the invention to provide an improvement on a control panel of a mobile phone to overcome the above disadvantages.

The mobile phone has a base, and a screen connected to the base besides the control panel. The base has a connecting post thereon, which has an engaging protrusion. The control panel has a hole on a lower side, and it has a gap next to the hole for allowing the engaging protrusion to pass through the gap while the connecting post is being passed through the hole. The base and the control panel are joined in a separable manner with the engaging protrusion being detained in the control panel by means of the lower side of the panel. The control panel further has a signal source on the lower side; after the control panel is separated from the base, it can be used to input data, which data will be transmitted to and displayed on the screen, and it can be used as a mouse to control a cursor on the screen.

### BRIEF DESCRIPTION OF THE DRAWINGS

The present invention will be better understood by referring to the accompanying drawings, wherein:

FIG. 1 is an exploded perspective view of the mobile phone according to the present invention,

FIG. 2 is a partial sectional view of the present mobile phone,

FIG. 3 is a view showing the way to move the control panel relative to the base according to the present invention, and

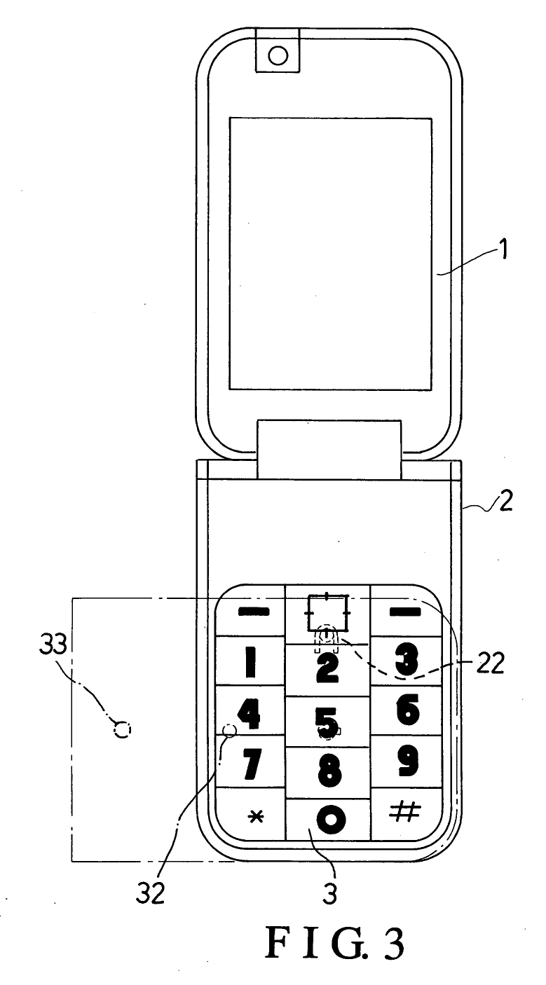

FIG. 4 is a view showing a way to use the present mobile phone.

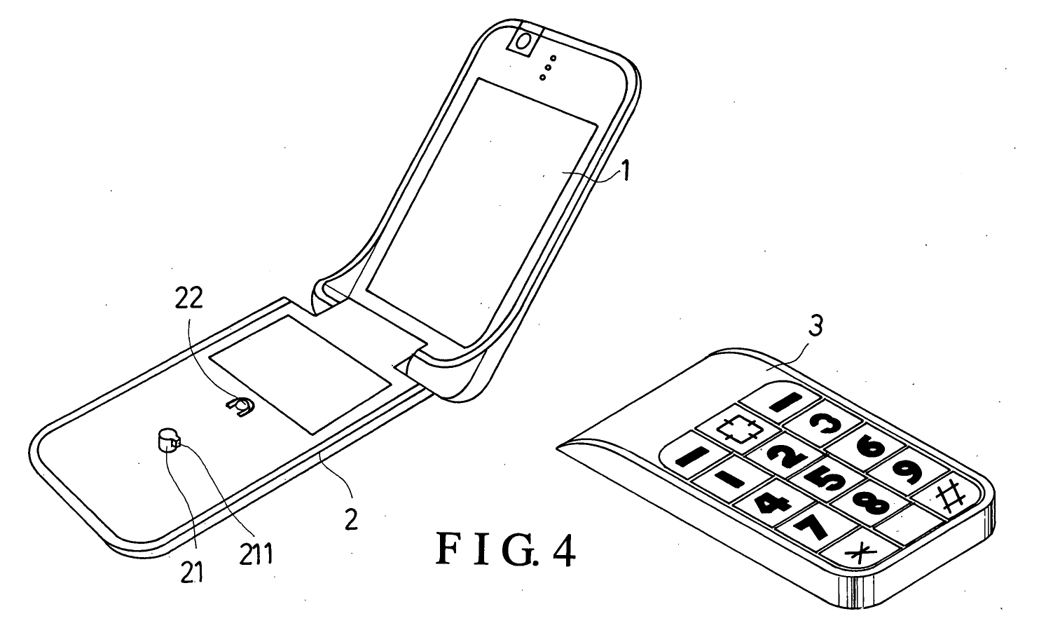

### DETAILED DESCRIPTION OF THE PREFERRED EMBODIMENTS

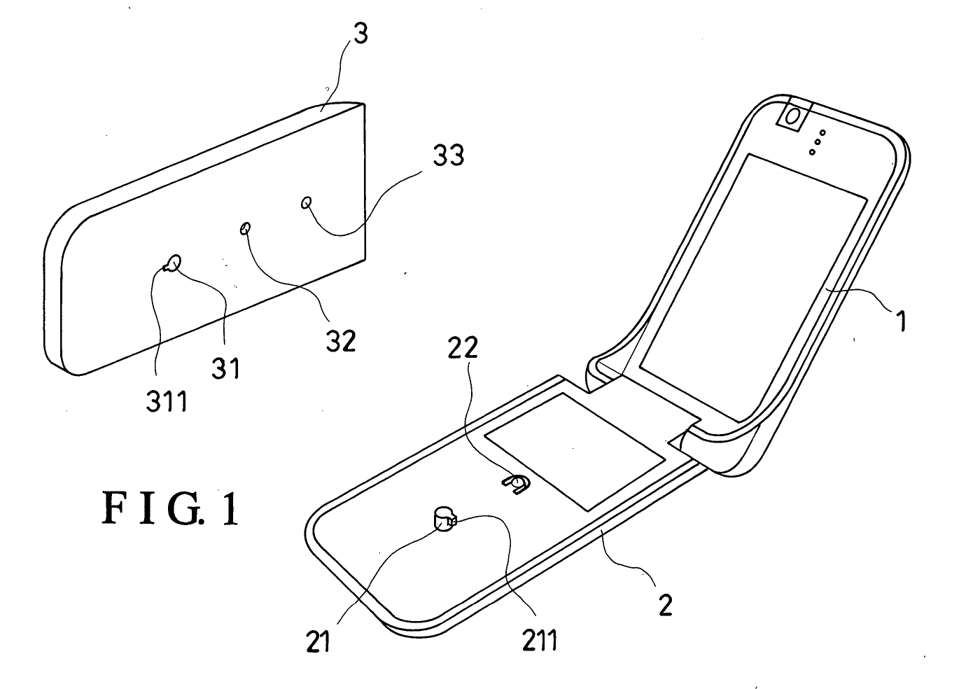

Referring to FIG. 1, a preferred embodiment of a mobile phone includes a screen 1, a base 2, and a control panel 3.

The base 2 is connected to the screen 1, and it has a connecting post 21, and an elastic fitting bump 22 thereon. Furthermore, an engaging protrusion 211 is formed on the connecting post 21.

The control panel 3 has a connecting hole 31, and a fitting cavity 32 on a lower side thereof. Furthermore, the lower side of the control panel 3 has a gap 311 next to the connecting hole 31. The distance between the connecting hole 31 and the fitting cavity 32 is equal to that between the connecting post 21 and the elastic fitting bump 22 of the base 2.

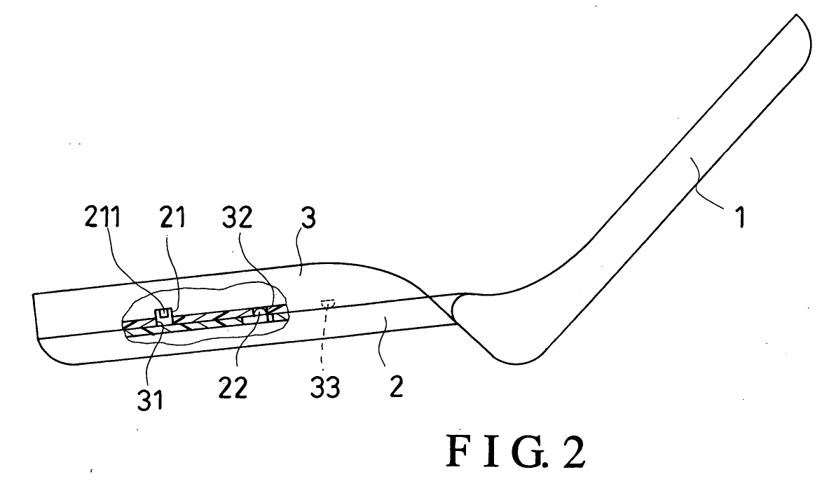

To join the base 2 and the control panel 3, first the connecting post 21 and the engaging protrusion 211 of the base 2 are respectively passed through the connecting hole 31 and the gap 311 of the lower side of the control panel 3. Next, the control panel 3 is turned around the connecting post 21 until the elastic fitting bump 22 is fitted into the fitting cavity 32; thus, the gap 311 of the lower side of the control panel 3 doesn't face the engaging protrusion 211 of the base 2, and the control panel 3 is steady on the base 2, as shown in FIG. 2.

Therefore, the control panel 3 can be turned around the connecting post 21, and it can be separated from the base 2 when the gap 311 faces the engaging protrusion 211 of the base 2. The control panel 3 can be used to input data, which data will be wirelessly transmitted to and displayed on the screen 1. Furthermore, the control panel 3 has a signal source 33 on the lower side thereof, which allows the control panel 3 to be used as a mouse to control a cursor on the screen 1; the cursor can be moved by means of moving the control panel 3 after the control panel 3 has been separated from the base 2.

From the above description, it can be easily understood that the control panel of the invention has an advantage: after the control panel is separated from the base, it can be used as a mouse to control the cursor on the screen, and it still can be used to input data. In other words, the control panel is very practical.

What is claimed is:

1. An improvement on a control panel of a mobile phone,
the mobile phone having a base, and a screen connected to the base; the base having a connecting post thereon; the connecting post having an engaging protrusion thereon;
the control panel having a connecting hole on a lower side thereof; the control panel having a gap next to the connecting hole on the lower side thereof for allowing the engaging protrusion to pass through the gap while the connecting post is being passed through the connecting hole; the control panel having a signal source on the lower side thereof;
the base and the control panel being joined in a separable manner with the engaging protrusion of the base being detained in the control panel by means of the lower side of the control panel; the control panel being capable of being used as a mouse after it is separate from the base.

2. The control panel as claimed in claim 1, wherein the base has an elastic fitting bump thereon, and the control panel has a fitting cavity on the lower side thereof for allowing the elastic fitting bump to be fitted-, in the fitting cavity when the base and the control panel are joined.
